(19) United States
(12) Patent Application Publication
(10) Pub. No.: US 2020/0067693 A1
(43) Pub. Date: Feb. 27, 2020

(54) SYSTEMS AND METHODS FOR MASKING ECC OPERATIONS

(71) Applicant: Maxim Integrated Products, Inc., San Jose, CA (US)

(72) Inventors: Frank Lhermet, Roquevaire (FR); Jeremy Dubeuf, La Ciotat (FR); Yann Yves Rene Loisel, La Ciotat (FR)

(73) Assignee: Maxim Integrated Products, Inc., San Jose, CA (US)

(21) Appl. No.: 16/547,385

(22) Filed: Aug. 21, 2019

(30) Foreign Application Priority Data
Aug. 21, 2018 (FR) 1857571

(51) Int. Cl. H04L 9/00; G06F 21/55; H04L 9/30

(52) U.S. Cl. CPC H04L 9/004; G06F 21/554; G06F 21/556; G06F 21/602; G06F 2221/2143; G06F 2221/034; H04L 9/3066

(57) ABSTRACT

Presented are low-cost secure systems and methods that protect cryptographic systems against attacks that seek to exploit the shortcomings of common software-based erasure mechanisms. Various embodiments, protect an Elliptic-Curve Cryptography (ECC) secret from fault attacks. This may be accomplished, for example, by not exposing ECC secrets from the Modular Arithmetic Accelerator (MAA) memory after a Destructive Reset Source (DRS).

### CROSS-REFERENCE TO RELATED APPLICATIONS

This application claims the priority benefit of French Patent Application No. 1857571, filed Aug. 21, 2018, entitled “Systems and Methods for Masking ECC Operations,” and listing as inventors Frank Lhermet, Jeremy Dubeuf, and Yann Yves Rene Loisel, which application is hereby incorporated by reference as to its entire content. Each reference mentioned in this patent document is incorporated by reference herein in its entirety.

### A. TECHNICAL FIELD

The present disclosure relates to information security and, more particularly, to secure systems and methods for preserving data confidentiality by providing a countermeasure against fault attacks on electric circuitry that performs security-related operations, such as Elliptic-Curve Cryptography (ECC) operations. The present disclosure further relates to secure systems and methods that protect cryptographic systems against attacks that seek to exploit the shortcomings of common software-based erasure mechanisms.

### B. BACKGROUND

ECC is known to present a great hurdle to potential attackers of encrypted data due to the elliptic curve discrete logarithm problem, i.e., finding a secret, private key, d, given a number of known parameters, including a public key, Q. Yet, Like any other cryptographic system, however, ECC systems are not immune to unauthorized access or inspection by potential attackers, e.g., side-channel attacks that exploit the fact that a cryptographic device such as a smart card leaks information into the environment. Monitoring the amount and location of leaks may then be directly or indirectly used to reveal cryptographic operations, such as decryption or signature generation operations executed on the device, from which confidential information may then be derived. Leaked information can be gathered when the device performs cryptographic operations, e.g., by monitoring and analyzing power consumption and timing patterns of the device or the electromagnetic radiation emitted therefrom; timing patterns of cryptographic operations; or the response of the device to induce errors to reverse engineer operations and determine confidential data.

A fault attack is a type of side-channel attack intended to exploit weaknesses in the implementation of a computer system to gain access to sensitive content. An active fault injection attack is a type of implementation attack that involves manipulating an otherwise secure system to leak exploitable information by injecting, during a cryptographic computation, a fault into computer system's implementation to force a faulted result that deviates from regular cryptographic operations such that the system's internal states may be revealed.

One type of fault attack is differential fault analysis, wherein the attacker observes a regular system response and then injects a fault, e.g., by manipulating an environmental condition of a microprocessor via a physical stimulus to induce the cryptographic algorithm to make a computational error made. Then by comparing the differences in the faulted and regular results, the attacker may obtain useful information, such as a secret key or a partial secret key. Differential fault analysis attacks are a common threat especially for embedded secure systems that use cryptographic algorithms such as RSA, ECC, etc. The attacker may inject a fault during a cryptographic computation. As a result the system may fail, e.g., a security certification test performed by a certification lab due to non-compliance with heightened security standards.

Common countermeasures to side-channel attacks in ciphering calculations include inserting one or more “dummy” operations, such as doubling or addition to, in effect, mask or hide actual cryptographic operations so as to prevent an attacker from being able to distinguish monitored operations from each other. Another countermeasure is a type of masking scheme that applies an exclusive OR operation to a random number and the secret key to obtain masked data, which hides the secret information since the secret key itself is not stored.

All these countermeasures, however, have their own drawbacks. For example, adding a number of dummy operations slows down the actual cryptographic process, which increases the computational cost to a level that may be unacceptable for various cryptographic applications. Therefore, some computer security standards require that confidential data be erased immediately following the detection of indicia of a tampering attempt with a cryptographic hardware device.

An Elliptic Curve Digital Signature Algorithm (ECDSA) is the elliptic curve equivalent of a DSA that a trusted certification authority may use to digitally sign a certificate for a plain text message. ECDSA signature computations involve scalar operations and simple modular operations like additions and multiplications. While some existing algorithms implement an elliptic scalar operation in an attempt to resist a fault attack, no known protection mechanisms exist that defend against more novel attacks for the rest of the ESCDSA, e.g., an attack outside the realm of the elliptic scalar operation itself.

In short, while for certain types of attacks countermeasures exist that can protect a trusted environment, there are no known solutions that provide a satisfactory level of protection against more invasive attacks, such as those aimed at intruding memory either by physical means or embedded software means. Especially in the field of ECC, common software-based erasure mechanisms cannot be relied upon for compliance with security standards when faced with such invasive attacks.

Accordingly, to ensure proper compliance and thwart fault attacks, it would be desirable to a systems and methods available that protect against attacks when performing cryptographic computations that may reveal sensitive information.

FIG. 1 illustrates a conventional system and method for protecting confidential data stored in memory. System 100 comprises Modular Arithmetic Accelerator (MAA) 102 that, typically, is a hardware device similar to a co-processor that has its own resources and provides support for mathematical computations. MAA 102 is oftentimes used for public key cryptography, which is demanding in terms of computing power, especially where software implementations are not powerful enough.

MAA 102 comprises registers and memory 106, e.g., SRAM, that receives operands, performs calculations, and outputs a result, e.g., a message m. As depicted in FIG. 1, MAA 102 is coupled to Non-Volatile Secure Random Access Memory (NVSRAM) 110 that, in operation, loads secret 104 into memory 106 of MAA 102, such that MAA 102 can calculate message m therefrom.

In case of an attack on system 100, a tamper alarm is triggered and, in response to a Destructive Reset Source (DRS), software erase command 130 is issued, e.g., by a tampering detection system, and communicated to NVSRAM 110, such that any partial secret present in memory 114, e.g., secret keys, can be cleared or erased to prevent unauthorized access to confidential data. However, in existing designs, such as system 100, memory 106 of MAA 102 cannot be erased in a timely fashion, because, by design, there exist no mechanisms or security features, whether in hardware or software, that can be relied on to perform a sufficiently rapid, complete, and guaranteed timely erasure of MAA memory 106. In part, this is due to the generally large memory region of memory 106. As a result, computations that have been performed and stored within MAA memory 106 and comprise any type of secret, remain within MAA memory 106 until they are actively erased e.g., via software. Thus, leave confidential information in MAA memory 106 is left vulnerable to access by potential attackers.

As an example, an attacker who can manage to issue a sufficiently fast reset command that interrupts the software-based erasure mechanism, for example, by interfering with the scheduling of the Non-Maskable Interrupt (NMI) handler to prevent the execution or completion of the interrupt, may gain access to the to-be-protected secret in MAA memory 106 that has not been erased following an alarm. Consequently, any attempt to comply with standards that require immediate erasure from memory that comprises confidential data may thus be thwarted by a successful attack.

Given the security issue that memory 106 cannot be timely erased in the event of a tampering attempt that is detected, in order to comply with applicable security and certification standards, it would, therefore, be desirable to have systems and methods in place that allow the use of an MAA while, at the same time, ensuring that no inadvertent exposure of secrets contained therein will occur.

In addition, a fault condition, such as one caused by a fault attack that causes a voltage glitch, can alter a private key. An ECDSA digital signature can, thus, be generated from a slightly different private key, i.e., a key that has a small number of bits that are different than the genuine private key (i.e., an expected private key). An attacker may accomplish this, for example, by utilizing a laser to irradiate a chip to so as to target a specific bit of a key in order to set a single bit of the key to a one or zero, such that the faulted private key that is not too far off from the expected private key. The attacker can then use the slightly different private key to generate an erroneous, i.e., invalid, ECDSA signature. The attacker may then derive from the genuine public key a private key that allows the validation of the faulted signature. Once this is accomplished, the attacker may then recover the small difference between the genuine and faulted private keys used during the ECDSA signature, based on the representation of the secret. What is needed are systems and methods that overcome these shortcomings and can withstand various types of physical and software attack.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments. Items in the figures may be not to scale.

FIG. 1 illustrates a conventional system and method for protecting confidential data stored in memory.

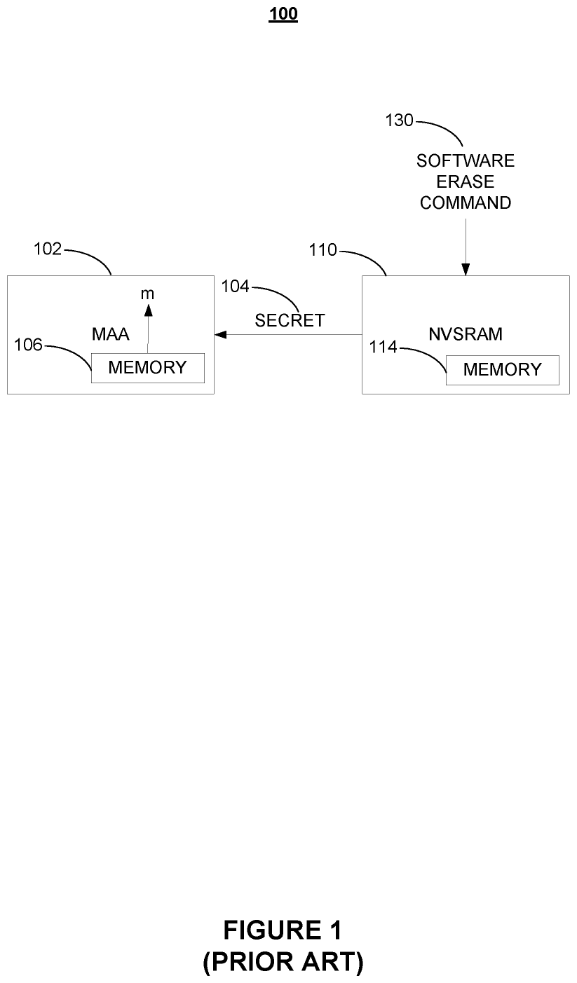

FIGS. 2A and 2B illustrate systems for protecting confidential data stored in memory to prevent unauthorized access and data manipulation, according to various embodiments of the present disclosure.

FIG. 3 is a flowchart of an illustrative process for protecting confidential data in accordance with various embodiments of the present disclosure.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components, or modules, shown in diagrams are illustrative of exemplary embodiments of the invention and are meant to avoid obscuring the invention. It shall also be understood that throughout this discussion components may be described as separate functional units, which may comprise sub-units. Those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. Furthermore, the use of memory, database, information base, data store, tables, hardware, and the like may be used herein to refer to system component or components into which information may be entered or otherwise recorded.

Furthermore, it shall be noted that: (1) certain steps may optionally be performed; (2) steps may not be limited to the specific order set forth herein; (3) certain steps may be performed in different orders; and (4) certain steps may be done concurrently.

Embodiments herein provide a successful countermeasure protect against fault attacks and protect the confidentiality of data executed on electronic circuitry that performs cryptographic operations, including ECC, for security-related applications. It is understood that embodiments described herein may be implemented by a state machine that uses wired logic or in software that executes instructions using a processing unit.

ECC is based on a multiplication of a quantity, P, which represents a point of an elliptic curve, and a scalar number, d, which serves as a secret integer that is to be protected from unauthorized access.

Embodiments of the present disclosure modify the generation of a public key, Q, and, thus, the representation as a secret quantity of the private key d. In embodiments, this is accomplished by splitting the private key d in a manner such that d comprises two components that together represent d. For example, instead of defining Q as a multiplication of d and P, Q may be defined as a multiplication of variables m₁, m₂, and P, wherein private key d is replaced by the product of m₁ and m₂. It is noted that while for purposes of explanation the product of variables m₁ and m₂ is discussed herein, it is understood that any combination of and number of variables and/or functions may be used to represent the private key d.

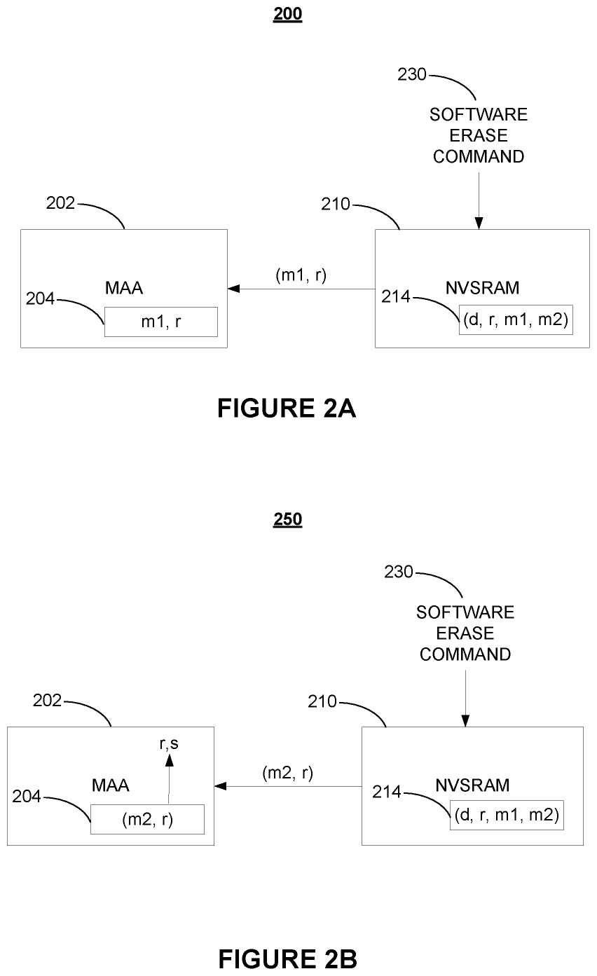

FIGS. 2A and 2B illustrate systems for protecting confidential data stored in memory to prevent unauthorized access and data manipulation, according to various embodiments of the present disclosure. As illustrated in FIG. 2A and FIG. 2B, in embodiments, variables m₁ and m₂ may be stored, e.g., in a register or memory 214 of NVSRAM device 210, and may be manipulated consecutively, e.g., in MAA memory 204, such that, at any given time either m₁ or m₂ are present in MAA memory 204, but not both together. In effect, this ensures that at least one portion of the private key d is stored within of secure memory 214 and at most one portion of the private key d is stored outside of secure memory 214. As a result, if either one of variables m₁ and m₂ is faulted, the resulting error will be useless to the attacker, as only one of the two variables is insufficient to recover the private key d.

In short, a sequence for the use of the secret components of the private key d provides for the erasure of one component while the other one, even if not erased, becomes useless by virtue of the incompleteness of private key d.

As an example, if the component m₁ (or m₂) of the private key d is faulted by a relatively small error e, then the resulting error, e multiplied by relatively large number m₂, becomes so large that it is virtually impossible to recover information about the private key, d, therefrom, by using a brute force attack or other techniques. This may be illustrated by the following ECSDA signature equations. The faulted signature is:

s≡k⁻¹(H(msg)+(m′₁±e)·(r·m₂))mod n

⇔s≡k⁻¹(H(msg)+(d/m₂±e)·(r·m₂))mod n

⇔s≡k⁻¹(H(msg)+(d±e·m₂)·(r)mod n

where s is the signature, H represents the hash function of a message, represents is a first part of the signature.

In embodiments, for example, after each signature generation, components m₁ and m₂ may be modified or updated using any type of mathematical operation to change the secret representation to further randomize operations and calculations.

As an example, variable m₁ may be divided by a random number, R, and variable m₂ may be multiplied by that random number, such that, here, the product m₁*m₂ still equals the private key d. In embodiments, to further increase system security, variables m₁ and m₂ may be newly generated to provide different numbers at different times. Advantageously, when combined with the random number, R, this creates an infinite number of combinations for m₁ and m₂ for any given private key, thereby, foreclosing the possibility that an attacker may use m₁ or m₂ to recover confidential information about a specific private key bit-by-bit using recursive attacks on the two variables. It is understood that other operations may be used to generate components of d, e.g., m₁=m₁/R mod n and m₂=m₂*R mod n, e.g., to protect against recursive attacks.

In summary, in the event of a DRS, the data in MAA memory 204 does not leak any secret information because with m₁ or m₂ but not both together can be found in MAA memory 204. However, as demonstrated above, both variable m₁ and m₂ would be needed to recover the private key d.

In embodiments, since by modifying m₁ or m₂, the secret is not represented the same way from update to update, this results in a randomization scheme of physical signatures that, as a further advantage, provides an effective countermeasure against side-channel attacks on the private key, such as differential power analysis (DPA) or correlation power analysis (CPA).

As will be apparent to the person skilled in the art, embodiments presented herein have several additional advantages. First ECC keys are relatively smaller than, for example, RSA keys. Therefore, storing variables m₁ and m₂ may require only, e.g., 1.5 or 2 times more space than the standard key itself. Second, the amount of additional computations during signature generation is relatively low since it may require only one additional multiplication, e.g., a modular multiplication, that may result in an overall increase of 1% of the computational burden. Therefore, the additional computation during key generation is not a great burden for most use cases.

In embodiments, NVSRAM device 210 may generate its own private and public key pairs, such that instead of generating private key d, variables m₁ and m₂ then Q may be generated. As a result, private key d never has to exist by itself.

In embodiments, computations and, thus, memory footprint requirements may be further reduced by using variables m₁ and m₂ that are shorter in length than the private key itself. For example, for a 256-bit private key, m₁ and m₂ do not have to be 256-bit long, but instead may have reduced sizes of only, e.g., 128-bit or 192-bit. It is understood that in order to ensure sufficiently strong keys, the size of the number of key bits should not be arbitrarily reduced but a trade-off should be made based on the actual implementation.

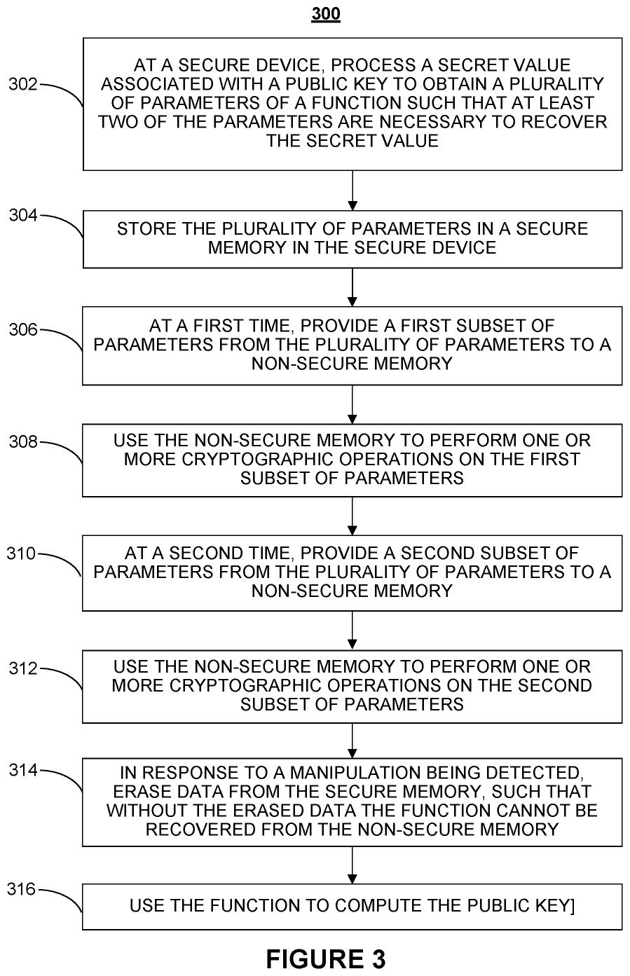

FIG. 3 is a flowchart of an illustrative process for protecting confidential data in accordance with various embodiments of the present disclosure. Process 300 for protecting confidential data begins at step 302 when a secret value that is associated with a public key is received and processed, e.g., by a secure device, in order to obtain a plurality of parameters of a function, such that at least two of the plurality of parameters of the function are necessary to recover the secret value.

At step 304, the plurality of parameters is stored in a secure memory in the secure device, e.g., a NVSRAM device.

At step 306, at a first time, a first subset of parameters from the plurality of parameters is provided to a non-secure memory, e.g., an MAA, to perform, at step 308, a number of cryptographic operations on the first subset of parameters.

At step 310, at a second time, a second subset of parameters is provided to the non-secure memory to perform, at step 312, a number of cryptographic operations on the second subset of parameters.

At step 314, in response to a manipulation, e.g., a temper attempt being detected, data is erased from the secure memory, such that without the erased data the function cannot be recovered from either the secure memory or the non-secure memory.

Finally, at step 316, the function is used to compute the public key.

Aspects of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present invention. One skilled in the art will also recognize that a number of the elements described above may be physically and/or functionally separated into sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall be noted that elements of the claims, below, may be arranged differently including having multiple dependencies, configurations, and combinations. For example, in embodiments, the subject matter of various claims may be combined with other claims.

What is claimed is:

1. A method for protecting confidential data comprising:
at a secure device, processing a secret value that is associated with a public key to obtain a plurality of parameters of a function such that at least two of the plurality of parameters of the function are necessary to recover the secret value;
storing the plurality of parameters in a secure memory in the secure device;
at a first time, providing, from the plurality of parameters, a first subset of parameters to a non-secure memory to perform one or more cryptographic operations on the first subset of parameters;
at a second time, providing, from the plurality of parameters, a second subset of parameters to the non-secure memory to perform one or more cryptographic operations on the second subset of parameters;
in response to a manipulation being detected, erasing data from the secure memory, such that without the erased data the function cannot be recovered from either the secure memory or the non-secure memory; and
using the function to compute the public key.

2. The method according to claim 1, further comprising, updating at least some of the plurality of parameters of the function to obtain a modified function from which the secret value can be recovered.

3. The method according to claim 1, wherein the non-secure memory is external to the secure device.

4. The method according to claim 1, wherein the secret value is an integer.

5. The method according to claim 1, wherein the manipulation is indicative of one of at least one of a software attack and a hardware attack.

6. The method according to claim 1, wherein computing the public key comprises using an ECC operation.

7. The method according to claim 1, wherein one or more of the plurality of parameters have a bit length that is less than the bit length of the secret value.

8. A non-transitory computer-readable medium or media comprising one or more sequences of instructions which, when executed by at least one processor, causes steps to be performed comprising:
using a secure device to process a secret value associated with a public key to obtain a plurality of parameters of a function such that at least two of the plurality of parameters of the function are necessary to recover the secret value;
storing the plurality of parameters in a secure memory in the secure device;
at a first time, providing, from the plurality of parameters, a first subset of parameters to a non-secure memory to perform one or more cryptographic operations on the first subset of parameters;
at a second time, providing, from the plurality of parameters, a second subset of parameters to the non-secure memory to perform one or more cryptographic operations on the second subset of parameters;
in response to a manipulation being detected, erasing data from the secure memory, such that without the erased data the function cannot be recovered from either the secure memory or the non-secure memory; and
using the function to compute the public key.

9. The secure device according to claim 14, wherein the steps further comprise, updating at least some of the plurality of parameters of the function to obtain a modified function from which the secret value can be recovered.

10. The secure device according to claim 14, wherein the non-secure memory is external to the secure device.

11. The secure device according to claim 14, wherein the manipulation is indicative of one of at least one of a software attack and a hardware attack.

12. The secure device according to claim 14, wherein computing the public key comprises using an ECC operation.

13. The secure device according to claim 14, wherein one or more of the plurality of parameters have a bit length that is less than the bit length of the secret value.

14. A secure device for protecting confidential data, the secure device comprising:
one or more processors to process a secret value that is associated with a public key to obtain a plurality of parameters of a function such that at least two of the plurality of parameters of the function are necessary to recover the secret value;
a secure memory that stores the plurality of parameters;
wherein the one or more processors are arranged to:
provide, at a first time, from the plurality of parameters, a first subset of parameters to a non-secure memory to perform one or more cryptographic operations on the first subset of parameters;
provide, at a second time, from the plurality of parameters, a second subset of parameters to the non-secure memory to perform one or more cryptographic operations on the second subset of parameters;
in response to a manipulation being detected, erase data from the secure memory, such that without the erased data the function cannot be recovered from either the secure memory or the non-secure memory; and
use the function to compute the public key,
using the function to compute the public key.

15. The secure device according to claim 14, wherein the steps further comprise, updating at least some of the plurality of parameters of the function to obtain a modified function from which the secret value can be recovered.

16. The secure device according to claim 14, wherein the secret value is an integer.

17. The secure device according to claim 14, wherein the non-secure memory is external to the secure device.

18. The secure device according to claim 14, wherein the manipulation is indicative of one of at least one of a software attack and a hardware attack.

19. The secure device according to claim 14, wherein computing the public key comprises using an ECC operation.

20. The secure device according to claim 14, wherein one or more of the plurality of parameters have a bit length that is less than the bit length of the secret value.
